(19) United States
(12) Patent Application Publication
(10) Pub. No.: US 2020/0175373 A1
(43) Pub. Date: Jun. 4, 2020

(54) METHOD FOR ANALYZING A SET OF PARAMETERS OF A NEURAL NETWORK

(71) Applicant: STMicroelectronics (Rousset) SAS, Rousset (FR)

(72) Inventors: Pierre Demaj, Nice (FR); Laurent Folliot, Gourdon (FR)

(21) Appl. No.: 16/680,840

(22) Filed: Nov. 12, 2019

(30) Foreign Application Priority Data
Nov. 29, 2018 (FR) 1872036

(51) Int. Cl. G06N 3/08; G06N 3/04

(52) U.S. Cl. CPC G06N 3/082; G06N 3/04

(57) ABSTRACT

A method can be used with a neural network being implemented by a system having a computation unit coupled to a collection of memories. The method includes analyzing a set of initial parameters defining an initial multilayer neural network. The analyzing includes attempting to reduce an initial memory size of an initial parameter so as to obtain a set of modified parameters defining a modified neural network with respect to the initial network.

### CROSS-REFERENCE TO RELATED APPLICATIONS

This application claims priority to French Patent Application No. 1872036, filed on Nov. 29, 2018, which application is hereby incorporated herein by reference.

### TECHNICAL FIELD

Modes of implementation and embodiments of the invention relate to a method for analyzing a set of parameters of a neural network.

### BACKGROUND

Neural networks are used massively to solve diverse statistical problems, in particular the problem of data classification.

After a phase of automatic learning, generally supervised, that is to say on an already classified reference database, a neural network “learns” and becomes capable on its own of applying the same classification to unknown data.

It is possible to cite convolutional neural networks, or CNNs, which represent a type of neural network in which the pattern of connection between the neurons is inspired by the visual cortex of animals. They allow efficient recognition of objects or people in images or videos.

The architecture of a neural network generally comprises a succession of layers each of which takes its inputs on the outputs of the previous layer.

The output data (“features”) are stored in memory areas having a previously defined size.

The input data are multiplied by at least one weight of a given value for each layer.

By “weight”, which is a term whose meaning in the field of neural networks is well known to the person skilled in the art, is meant parameters of neurons that can be configured to obtain good output data.

This weight is determined by training the neural network on a training database. More precisely, the neural network processes for example an image extracted from the database and at output it makes a prediction, that is to say to which class could the image belong, given that the class of the image is previously known.

As a function of the veracity of this result, all the weights of the neural network are updated according to an algorithm which is called gradient backpropagation.

Generally, the output data and the weights of each layer are represented in floating point for example on 32 bits, thereby making it possible to have a neural network with better performance as regards predictions.

The output data and the weights of each layer can also be represented in fixed point for example on 16 or 8 bits.

By “floating point” is meant a representation of a number by a sign, a mantissa and an exponent.

By “fixed point” is meant a representation of a number with a fixed number of digits after the point.

The memory areas allocated for fixed point representations are consequently smaller than those allocated for floating point representations.

Generally, the smaller the memory size, the more the neural network loses in terms of performance with respect to the predictions since the accuracy of the computations is degraded.

Today, neural networks are ever more complex and require large computational power.

The instruction per second is a unit of measurement of the performance of a system for example a microprocessor.

For a given microprocessor, the more complex the configuration of the neural network, the more the time necessary to carry out an inference, that is to say the execution of all the layers of the neural network, increases.

Moreover, the microprocessors of systems storing a neural network are generally optimized for data represented in fixed point for example on 16 or 8 bits.

### SUMMARY

Modes of implementation and embodiments of the invention relate to deep learning and more particularly to deep neural networks.

Therefore a need exists to be able, to the extent possible, to offer to implement complex neural networks on a microprocessor while not degrading, or at the very least to an acceptable extent, the performance.

It is thus proposed to offer a user of a neural network the ability to be able to decide whether it is possible, as a function of a criterion preferentially chosen by this user, to modify or to tailor certain parameters of the neural network, for example the size of the weights and/or of the output data, so as to obtain for example a gain in terms of memory or a gain in performance, for example a gain in processing time, at the processor level while preserving good performance for the neural network thus modified.

It is also proposed to be able to determine whether it is possible to reduce the computational load for example of a microprocessor processing the data received or created by a neural network by passing from a floating point data representation to a fixed point representation while preserving an efficacious neural network.

### BRIEF DESCRIPTION OF THE DRAWINGS

FIG. 1 schematically illustrates a mode of implementation and embodiment of the invention.

FIG. 2 schematically illustrates a mode of implementation and embodiment of the invention.

FIG. 3A schematically illustrates a mode of implementation and embodiment of the invention.

FIG. 3B schematically illustrates a mode of implementation and embodiment of the invention.

FIG. 3C schematically illustrates a mode of implementation and embodiment of the invention.

FIG. 3D schematically illustrates a mode of implementation and embodiment of the invention.

FIG. 4A schematically illustrates a mode of implementation and embodiment of the invention.

FIG. 4B schematically illustrates a mode of implementation and embodiment of the invention.

### DETAILED DESCRIPTION OF ILLUSTRATIVE EMBODIMENTS

According to one aspect, a method comprises analysis of a set of initial parameters defining an initial multilayer neural network. The neural network is intended to be implemented by a system comprising a computation unit, for example a processor coupled to a collection of memories. The analysis comprises, in particular with a view to obtaining a technical improvement comprising for example at least one improvement in the processing duration of the computation unit and/or a gain of memory size, a reduction or an attempted reduction of the initial memory size of at least one initial parameter so as to obtain a set of modified parameters defining a modified neural network with respect to the initial network.

This reduction or attempted reduction is advantageously conditioned on the satisfaction or non-satisfaction of a criterion, for example chosen.

According to one mode of implementation, the method further comprises an implementation by the system, of the initial neural network and of the modified neural network by using a test input data set, a formulation of a quality factor for the initial neural network and of a quality factor for the modified neural network by using at least the test input data set, a comparison between the two quality factors and an acceptance or a refusal of the reduction of the initial memory size of the at least one parameter as a function of the result of the comparison with regard to the satisfaction or non-satisfaction of the chosen criterion.

This criterion is for example chosen by the user of the neural network, as a function for example of the envisaged application.

The type of technical improvement can also be advantageously chosen, for example by the user, in particular as a function of the envisaged application, of the hardware constraints and budgetary constraints.

This choice can then condition as regards which type of initial parameter can carry the reduction of the memory size.

The term “set of initial parameters” is meant as parameters relating to the configuration of the neural network, for example the weights of each layer, its type and the size to be allocated for the output data of each layer.

Each parameter having a defined memory size, a modified neural network is a network where the memory size of one or of all of the initial parameters has been modified for example by reducing the memory size.

As a function of the technical improvement sought (gain in memory and/or gain in performance (in particular in processing time) of the processor for example), it will be possible for example to seek to reduce the initial memory size allocated to one or to several layers of the neural network and/or reduce the initial memory size of some at least of the weights of some at least of the layers modifying the representation of the data (floating to fixed point).

To verify whether a modification of the set of initial parameters satisfies the chosen criterion, a test input data set is input to the modified neural network. This set of data serves to evaluate the performance of the neural network by computing a quality factor.

The quality factor for the initial network and the quality factor for the modified network are computed and they are compared.

This quality factor may be for example a precision factor or a noise factor without these examples being limiting.

If the two quality factors are identical to within a tolerance, for example a few per cent, chosen by the user, then it is considered that the criterion is satisfied, that is to say that the modified neural network allows for example a gain in memory while retaining substantially the same performance as the initial neural network.

If the two quality factors are not identical to within the tolerance, then it is considered that the criterion is not satisfied, that is to say that the gain in memory for example, obtained with the modified neural network does not make it possible to obtain the same performance as that obtained with the initial neural network.

If the new modified neural network does not satisfy the criterion, the system retains the initial neural network and erases the new one.

If the new modified neural network satisfies the criterion, the new neural network can for example replace the initial neural network.

According to one mode of implementation, each layer of the initial neural network comprises at least one initial weight belonging to the set of initial parameters and having an initial memory size.

The analysis comprises a first reduction of the initial memory size of the at least one initial weight to a first memory size for all the layers, and in case of refusal of the first reduction after the comparison of the quality factors, a second reduction of the at least one weight to a second memory size for all the layers, the second size being greater than the first size, and in case of refusal of the second reduction after the comparison of the quality factors, a retaining of the initial memory size of the initial weights of the initial neural network.

The initial memory size of the at least one weight is allocated in a non-volatile memory for example a ROM memory (“Read-Only Memory”).

The initial memory size of the at least one weight is for example 32 bits. A first reduction of the initial memory size of the at least one weight is for example a reduction of 24 bits. The at least one weight therefore has a modified memory size of 8 bits.

The expected technical improvement is for example a gain in memory.

Given that the at least one weight loses in terms of precision, it is advantageous to verify whether the modified neural network satisfies the criterion. For this purpose, the comparison of the quality factors is performed.

If there is refusal, the initial memory size of the at least one weight is reduced less heavily so as to have a memory size of 16 bits. The comparison between a modified neural network in which the at least one weight has a memory size of 16 bits is performed again with the initial neural network in which the at least one weight has its initial memory size, that is to say 32 bits.

If there is refusal, the initial memory size, that is to say here 32 bits, is preserved.

It is also possible to have an initial neural network in which the at least one weight has an initial size of 8 bits. In this case, it is for example possible to carry out a first reduction of 6 bits so as to have a memory size of 2 bits and perform the comparison of the quality factors. If there is refusal, it is possible to carry out a second lesser reduction, for example of 4 bits, that is to say, have a final memory size of 4 bits and perform the comparison of the quality factors and if there is refusal, the initial memory size of 8 bits is retained.

According to another possible mode of implementation, each layer of the initial neural network comprises an initial memory area intended to store output data, belonging to the set of initial parameters and having an initial memory size.

The method comprises, if the memory size of the at least one initial weight has been reduced, a first reduction of the initial memory size of all the initial memory areas to the first size, and in case of refusal of the first reduction after the comparison of the quality factors, a second reduction of the initial memory size of all the initial memory areas to the second size, and in case of refusal of the second reduction after the comparison, a retaining of the initial memory size of the initial memory areas of the network.

The initial memory size of the memory area is allocated in a volatile memory for example a RAM memory (“Random Access Memory”).

The initial memory size of the memory area is for example 32 bits. In this case, if the memory size of the at least one weight has been reduced, a first reduction of the initial memory size of the memory area of 24 bits is carried out. The memory area therefore has a memory size of 8 bits.

Given that the memory area thus reduced loses in terms of precision, it is advantageous to verify whether the modified neural network satisfies the criterion. For this purpose, the comparison of the quality factors is performed.

If there is refusal, the initial memory size of the memory area is reduced less heavily so as to have 16 bits. The comparison between a modified neural network in which the memory area has a memory size of 16 bits is performed with the initial neural network in which the memory area has an initial memory size, that is to say 32 bits.

If there is refusal, the initial memory size, that is to say here 32 bits, is preserved.

It is also possible to have an initial neural network in which the memory area has an initial size of 8 bits. In this case, it is for example possible to carry out a first reduction of 6 bits so as to have a memory size of 2 bits and perform the comparison. If there is refusal, it is possible to carry out a second reduction of 4 bits, that is to say, have a memory size of 4 bits and perform the comparison and if there is refusal, the initial memory size 8 bits is retained.

According to one mode of implementation, the second size is double the first size.

For example, if the initial memory size is 32 bits, the first reduction makes it possible to obtain a memory size of 8 bits and a memory size of 16 bits after the second reduction.

According to one mode of implementation, on completion of the analysis, the set of modified parameters of the modified neural network can comprise the at least one weight having a reduced memory size and all the initial memory areas having a reduced memory size.

For example, if the set of initial parameters of the initial neural network comprises the at least one weight having an initial memory size of 32 bits and the initial memory areas having an initial memory size of 32 bits, the set of modified parameters of the modified neural network comprises the at least one weight having a memory size of 8 or 16 bits and the memory areas having a memory size of 8 or 16 bits.

According to another possibility, the set of modified parameters of the modified neural network can comprise the at least one weight having a reduced memory size and all the initial memory areas having their initial memory size.

Stated otherwise, in this case, the reduction of the memory size of the at least one weight has been advantageous, that is to say it makes it possible to remain close to the performance of the initial neural network but only if one does not reduce the memory size of the initial memory areas.

According to one mode of implementation, the at least one quality factor comprises a precision factor.

The precision factor, for example “Mean Average Precision,” is a measure for evaluating the neural network. This makes it possible to obtain the average of the percentages computed for each class. Each percentage corresponds to the number of data that have been correctly predicted.

Another precision factor would for example be “Accuracy” which is also a measure for evaluating the neural network. This entails the ratio between the number of correct classifications to the number of classifications executed. Several variants exist and are known to the person skilled in the art. For example it is possible to evaluate the neural network for a given class.

According to one mode of implementation, the at least one quality factor comprises a noise factor.

By “noise factor”, within the framework of the neural network, it is possible to cite the mean square error which makes it possible to compare, at the level of the layers of the neural network, the data at the output of each layer of the initial neural network and of the modified neural network. Another variant would be to compare the data at the input of each layer. This comparison can for example be performed by testing the two neural networks with a test set of random data at the input of both networks.

According to another variant, each layer of the initial neural network comprises at least one initial weight belonging to the set of initial parameters and having an initial memory size.

The analysis comprises a first reduction of the memory size of the at least one weight of the layer to a first memory size, and in case of refusal of the first reduction after the comparison of the quality factors, a second reduction of the initial memory size of the at least one initial weight of the layer to a second memory size greater than the first memory size, and in case of refusal of the second reduction after the comparison, a retaining of the initial memory size of the at least one weight of the layer.

Each layer of the initial neural network comprises an initial memory area having an initial memory size intended to store output data, belonging to the sets of initial parameters.

The analysis then also comprises a first reduction of the initial memory size of the initial memory area of the layer to the first size, and in case of refusal of the first reduction after the comparison, a second reduction of the initial memory size of the initial memory area of the layer to the second size, and in case of refusal of the second reduction after the comparison, a retaining of the initial memory size of the initial memory area and of the initial memory size of the at least one initial weight of the layer.

Here, the first and the second reduction are performed solely per layer.

A modified neural network can thus for example comprise a set of parameters modified solely for a single layer.

According to yet another variant, in which each layer of the initial neural network comprises at least one initial weight and an initial memory area intended to store output data, belonging to the set of initial parameters, the at least one weight having an initial memory size equal to the initial memory size of the initial memory area, the analysis comprises a reduction by half of the initial memory size of the at least one initial weight of the layer, and in case of refusal of the reduction after the comparison of the quality factors, a retaining of the initial memory size of the at least one initial weight and a reduction by half of the initial memory size of the initial memory area, and in case of refusal of the reduction in memory size of the initial memory area after the comparison of the quality factors, a retaining of the initial memory size of the initial memory area.

According to yet another variant in which each layer of the initial neural network comprises at least one initial weight and an initial memory area intended to store output data belonging to the set of initial parameters, the at least one weight having an initial memory size greater than the initial memory size of the initial memory area, the analysis comprises a reduction of the initial memory size of the at least one initial weight to the initial memory size of the initial memory area, and in case of refusal after the comparison of the quality factors a retaining of the initial memory size of the at least one weight.

According to yet another variant in which each layer of the initial neural network comprises at least one initial weight and an initial memory area intended to store output data, belonging to the set of initial parameters, the at least one initial weight having an initial memory size smaller than the initial memory size of the initial memory area, the analysis comprises a reduction of the initial memory size of the initial memory area to the initial memory size of the at least one initial weight, and in case of refusal of the reduction after the comparison of the quality factors, a retaining of the initial memory size of the initial memory area.

According to one mode of implementation, the at least one quality factor comprises a precision factor.

According to one mode of implementation, the at least one quality factor comprises a noise factor.

According to one mode of implementation, the method further comprises a computation of a score for each layer of the initial neural network as a function of the technical improvement sought and a selection of the layers having a score above a threshold.

The reduction of the memory size of a memory area and/or of the memory size of the weights of a layer can potentially lead to the improvement sought.

To select these potential layers, a score is computed for each layer. If the computed score is smaller than a threshold for example o, this means that the layer does not lead to the improvement sought after reduction of the memory size of its memory area and/or of the memory size of its weights. It would not be useful to carry out the reduction on this layer.

It is also possible to carry out the reduction on the layer but the layer will not have priority with respect to the potential layers.

The layers of the neural network are classified as a function of the score obtained.

According to one mode of implementation, each selected layer of the initial neural network comprises at least one initial weight having an initial memory size and an initial memory area intended to store output data, having an initial memory size, the analysis comprising a reduction of the initial memory size of the initial memory area and/or of the at least one weight of the selected layer to a chosen size, and in case of refusal of the reduction after the comparison, a retaining of the initial memory size of the at least one initial weight and/or of the initial memory area and a passage to the following selected layer.

According to one mode of implementation, the technical improvement sought is a gain in memory.

According to one mode of implementation, the collection of memories of the system comprises a volatile memory intended to be allocated to the initial memory area of the selected layer and a non-volatile memory intended to store the at least one weight of the selected layer, and as a function of a weighting factor, the gain in memory comprises a gain in volatile memory or non-volatile memory or a gain in both memories, the gain in non-volatile memory corresponding to a reduction of the initial memory size of the at least one weight of the selected layer, the gain in volatile memory corresponding to a reduction of the initial memory size of the initial memory area of the selected layer.

For example, if the gain thereof is sought in the volatile memory, it would be advantageous to reduce the initial memory size of the memory areas of each selected layer.

If the gain in memory is sought in the non-volatile memory, it would be advantageous to reduce the initial memory size of the weights of each layer.

If a weighting factor is defined for example 0.5, this confers the same importance on the gain in volatile memory and in non-volatile memory.

According to one mode of implementation, the technical improvement sought is a gain in processing duration.

By “a gain in processing duration” is meant a gain in processing time at the level of the computation unit.

According to one mode of implementation, the at least one quality factor comprises a precision factor.

According to one mode of implementation, the at least one quality factor comprises a noise factor.

According to another aspect, there is proposed a system comprising a computation unit, for example a processor coupled to a collection of memories. The computation unit comprising an analysis unit configured to perform an analysis of a set of initial parameters defining an initial multilayer neural network intended to be implemented by the system, the analysis unit being configured to, in particular with a view to obtaining a technical improvement comprising for example at least one improvement in the processing duration of the computation unit and/or a gain of memory size, reduce or attempt to reduce the initial memory size of at least one initial parameter so as to obtain a set of modified parameters defining a modified neural network with respect to the initial network.

In this context, an analysis unit is a circuit having electronic components such as transistors or software programmed to be executed by the computation unit (or a combination of hardware and software).

The analysis unit is advantageously configured to condition the reduction or the attempted reduction of the initial memory size of at least one initial parameter, on the satisfaction or non-satisfaction of a criterion.

According to one embodiment, the computation unit is furthermore configured to implement the initial neural network and the modified neural network by using a test input data set, and the analysis unit is configured to formulate a quality factor for the initial neural network and a quality factor for the modified neural network by using the at least one test input data set, to perform a comparison between the two quality factors, and to deliver an acceptance or refusal decision in respect of the reduction of the initial memory size of the at least one parameter as a function of the result of the comparison with regard to the satisfaction or non-satisfaction of the chosen criterion.

According to one embodiment, each layer of the initial neural network comprises at least one initial weight belonging to the set of initial parameters and having an initial memory size, the analysis unit being configured to perform a first reduction of the initial memory size of the at least one initial weight to a first memory size for all the layers, and in case of refusal of the first reduction after the comparison by the computation unit, the analysis unit is configured to perform a second reduction of the at least one weight to a second memory size for all the layers, the second memory size being greater than the first memory size, and in case of refusal of the second reduction after the comparison by the computation unit, the analysis unit is configured to retain the initial memory size of the initial weights of the initial neural network.

According to one embodiment, each layer of the initial neural network comprises an initial memory area intended to store output data, belonging to the set of initial parameters and having an initial memory size, the analysis unit being configured to, if the initial memory size of the at least one initial weight has been reduced, perform a first reduction of the initial memory size of all the initial memory areas to the first size, and in case of refusal of the first reduction after the comparison by the computation unit, the analysis unit is configured to perform a second reduction of the initial memory size of all the initial memory areas to the second size, and in case of refusal of the second reduction after the comparison by the computation unit, the analysis unit is configured to retain the initial memory size of the initial memory areas.

According to one embodiment, the second size may be double the first size.

According to one embodiment, the set of modified parameters of the modified neural network comprises the at least one weight having a reduced memory size and all the initial memory areas having a reduced memory size.

According to one embodiment, the modified set of parameters of the modified neural network comprises the at least one weight having a reduced memory size and all the initial memory areas having their initial memory size.

According to one embodiment, the at least one quality factor is the precision.

According to one embodiment, the at least one quality factor is the noise.

According to one embodiment, each layer of the initial neural network comprises at least one initial weight belonging to the set of initial parameters and having an initial memory size, the analysis unit being configured to perform a first reduction of the memory size of the at least one weight of the layer to a first memory size, and in case of refusal of the first reduction after the comparison by the computation unit, the analysis unit is configured to perform a second reduction of the initial memory size of the at least one initial weight of the layer to a second memory size greater than the first memory size, and in case of refusal of the second reduction after the comparison by the computation unit, the analysis unit is configured to retain the initial memory size of the at least one weight of the layer.

Moreover each layer of the initial neural network comprising an initial memory area intended to store output data, belonging to the sets of initial parameters and having an initial memory size, the analysis unit is also configured to perform a first reduction of the initial memory size of the initial memory area of the layer to the first size, and in case of refusal of the first reduction after the comparison by the computation unit, the analysis unit is configured to perform a second reduction of the initial memory size of the initial memory area of the layer to the second size, and in case of refusal of the second reduction after the comparison by the computation unit, the analysis unit is configured to retain the initial memory size of the initial memory area and of the initial memory size of the at least one initial weight of the layer.

According to one embodiment, each layer of the initial neural network comprises at least one initial weight and an initial memory area intended to store output data, belonging to the set of initial parameters, the at least one weight having an initial memory size equal to the initial memory size of the initial memory area, the analysis unit being configured to perform a reduction by half of the initial memory size of the at least one initial weight of the layer, and in case of refusal of the reduction after the comparison by the computation unit, the analysis unit is configured to retain the initial memory size of the at least one initial weight and to perform a reduction by half of the initial memory size of the initial memory area, and in case of refusal of the reduction of the initial memory size of the initial memory area after the comparison, the analysis unit is configured to retain the initial memory size of the initial memory area.

According to one embodiment, each layer of the initial neural network comprises at least one initial weight and an initial memory area intended to store output data, belonging to the set of initial parameters, the at least one weight having an initial memory size greater than the initial memory size of the initial memory area, the analysis unit being configured to perform a reduction of the initial memory size of the at least one initial weight to the initial memory size of the initial memory area, and in case of refusal after the comparison by the computation unit, the analysis unit is configured to retain the initial memory size of the at least one weight.

According to one embodiment, each layer of the initial neural network comprises at least one initial weight and an initial memory area intended to store output data, belonging to the set of initial parameters, the at least one initial weight having an initial memory size smaller than the initial memory size of the initial memory area, the analysis unit being configured to reduce the initial memory size of the initial memory area to the initial memory size of the at least one initial weight, and in case of refusal of the reduction after the comparison by the computation unit, the analysis unit is configured to retain the initial memory size of the initial memory area.

According to one embodiment, the analysis unit is configured to process the layers of the initial neural network from the first to the last layer and/or from the last to the first layer.

According to one embodiment, the at least one quality factor comprises a precision factor.

According to one embodiment, the at least one quality factor e comprises a noise factor.

According to one embodiment, the computation unit is configured to compute a score for each layer of the initial neural network as a function of the technical improvement sought and to select the layers having a score above a threshold.

According to one embodiment, each layer selected by the analysis unit comprises at least one weight having an initial memory size and an initial memory area intended to store output data and having an initial memory size, the analysis unit being configured to perform the reduction of the initial memory size of the initial memory area and/or of the at least one weight of the selected layer to a chosen size, and in case of refusal of the reduction after the comparison by the computation unit, the analysis unit is configured to retain the initial memory size of the at least one initial weight and/or of the initial memory area, and to pass to the following selected layer.

According to one embodiment, the technical improvement sought is a gain in the whole collection of memories.

According to one embodiment, the collection of memories of the system comprises a volatile memory intended to be allocated to the initial memory area of the selected layer and a non-volatile memory intended to store the at least one weight of the selected layer, and as a function of a weighting factor, the gain in memory comprises a gain in volatile memory or non-volatile memory or a gain in both memories, the gain in non-volatile memory corresponding to a reduction of the initial memory size of the at least one weight of the layer selected by the analysis unit, the gain in volatile memory corresponding to a reduction of the initial memory size of the initial memory area of the layer selected by the analysis unit.

According to one embodiment, the technical improvement sought is a gain in processing time.

According to one embodiment, the at least one quality factor comprises a precision factor.

According to one embodiment, the at least one quality factor comprises a noise factor.

According to another aspect, there is also proposed a microcontroller comprising the system such as defined hereinabove.

Reference will now be made to the drawings.

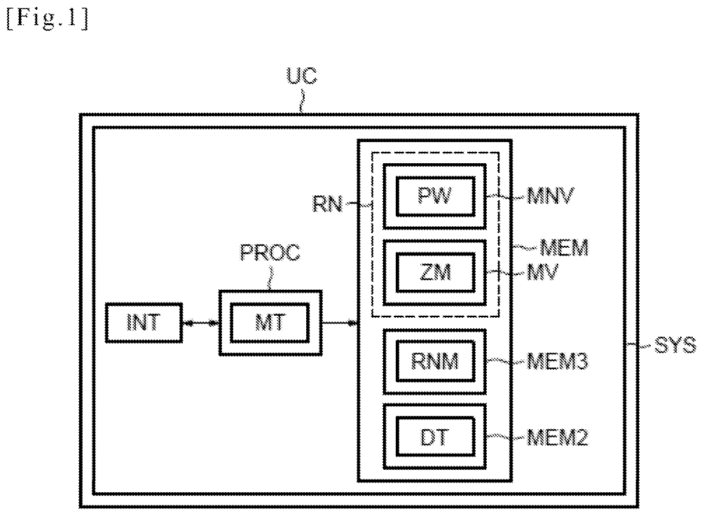

In FIG. 1, the reference UC designates an electronic object for example a microcontroller, a code generator or any other object that may contain a hardware architecture or embedded software architecture.

The object UC comprises a system SYS for example a module configured to implant an initial neural network RN, and comprising a collection of memories MEM, a computation unit (here a processor) PROC and a user interface INT.

The collection of memories MEM is coupled to the processor PROC and comprises a non-volatile memory MNV for example a ROM memory (“Read-Only Memory”). The non-volatile memory is configured to store the configuration of the neural network RN for example the various layers characterizing it and its weights PW.

The collection of memories MEM also comprises a volatile memory MV for example a RAM memory (for “Random Access Memory”). The volatile memory MV is configured to store initial memory areas ZM intended to contain the output data of each layer of the initial neural network RN.

The initial weights PW and memory areas represent a set of initial parameters of the initial neural network RN.

The collection of memories MEM also comprises a memory MEM3 configured to store the data relating to a set of modified parameters of a modified neural network RNM.

Once the modification of the configuration of the modified neural network RNM has terminated, the processor PROC is configured to store the set of modified parameters of the modified neural network RNM in place of the set of initial parameters of the initial neural network RN.

It comprises a memory MEM2 configured to store a test input data set DT for example a non-volatile memory ROM.

The test input data set is configured to evaluate the performance of the initial neural network RN or the performance of the modified neural network RNM by computing a quality factor.

The processor PROC comprises an analysis unit MT, embodied for example in software form, configured to perform an analysis of the set of initial parameters defining the neural network RN, reduce the initial memory size of at least one initial parameter of the neural network RN and obtain the set of modified parameters defining the modified neural network RNM.

The analysis unit MT is configured to perform the reduction with a view to obtaining a technical improvement, for example an improvement in the processing duration of the processor PROC and/or a gain in memory size of the collection of memories MEM.

In this regard the analysis unit MT is configured to compute the quality factor for the initial network and the quality factor for the modified network and to compare these two quality factors.

The refusal or the acceptance of the reduction of the memory size of at least one initial parameter of the initial network will depend on the result of the comparison with regard to the satisfaction or non-satisfaction of a criterion advantageously chosen by the user of the neural network.

Thus, if for example the two quality factors are identical to within a tolerance, for example a few per cent, then it is considered that the criterion is satisfied, that is to say that the modified neural network allows for example a gain in memory while retaining substantially the same performance as the initial neural network.

If on the other hand the two quality factors are not identical to within the tolerance, then it is considered that the criterion is not satisfied, that is to say that the gain in memory for example, obtained with the modified neural network does not make it possible to obtain the same performance as that obtained with the initial neural network.

This tolerance, which intervenes in the determination of the satisfaction or of the non-satisfaction of the criterion (advantageously chosen by the user), is therefore also advantageously chosen by the user.

The processor PROC is coupled to the user interface INT configured to allow the user to choose the criterion, that is to say here to deliver to the system the value of the tolerance.

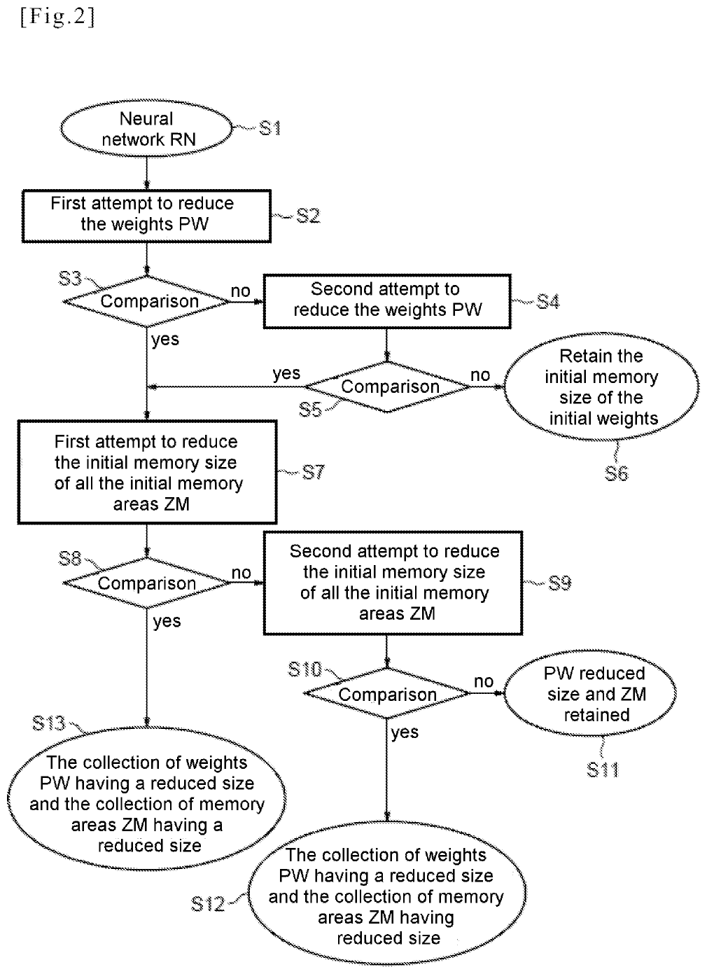

FIG. 2 represents an algorithm for analyzing the set of initial parameters defining the neural network RN.

In step S1, the processor PROC extracts the set of initial parameters of the neural network RN for example the weights PW of all the layers.

The analysis unit MT performs a first reduction of the initial memory size of the weights PW of the neural network RN in step S2.

For example, if the initial memory size of the weights PW is 32 bits, the analysis unit MT reduces the initial size by 24 bits. The weights PW therefore each have a new first memory size of 8 bits. By modifying the set of initial parameters of the neural network, the neural network is therefore modified.

In step S3, the processor PROC implements the modified neural network RNM by using the test input data set DT so as to formulate a quality factor for example the precision (“Mean Average Precision”). A precision of 90% is for example obtained. It is also possible to formulate another quality factor for example “accuracy” known to the person skilled in the art.

The processor PROC compares in step S3 the quality factor formulated with another quality factor previously formulated during the implementation of the initial neural network RN for example 95%. There is therefore a difference of 5% between the two quality factors.

If this difference is situated in the tolerance fixed by the user via the interface INT, the criterion is satisfied and the algorithm passes to step S7 otherwise it passes to step S4.

In step S4, the analysis unit MT performs a second reduction of the initial memory size of the weights PW to obtain for example a second memory size greater than the first memory size, for example 16 bits.

In step S5, the processor PROC implements the modified neural network by using the test input data set DT so as to formulate a quality factor for example the precision. A precision of 92% is for example obtained.

The processor PROC compares the quality factor formulated with another quality factor previously formulated during the implementation of the initial neural network RN for example 95%. There is therefore a difference of 3%.

If this difference is situated in the tolerance fixed by the user via the interface INT (for example +/−3%), the criterion is satisfied and the algorithm passes to step S7, otherwise the processor PROC retains the initial memory size of the weights PW and therefore retains the initial neural network RN.

In step S7, after reduction of the weights PW, the analysis unit MT performs a first reduction of the memory size of the memory areas ZM intended to store the output data of each layer of the neural network RN.

For example, if the initial memory size of the initial memory area ZM is 32 bits, the analysis unit MT reduces the initial size by 24 bits. The initial memory areas ZM therefore each have a new first memory size of 8 bits. By modifying the set of initial parameters of the neural network RN, the neural network is therefore modified.

In step S8, the processor PROC implements the modified neural network RNM by using the test input data set DT so as to formulate a quality factor for example the precision. A precision of 90% is for example obtained.

The processor PROC compares in step S8 the quality factor formulated with another quality factor previously formulated during the implementation of the initial neural network RN for example 95%. There is therefore a difference of 5%.

If this difference is situated in the tolerance fixed by the user via the interface INT, the criterion is satisfied and the processor PROC replaces in step S13 the neural network RN by the modified neural network RNM in which the collection of its weights PW and the collection of memory areas ZM have their modified initial size. Otherwise, we pass to step S9.

In step S9, the analysis unit MT performs a second reduction of the initial memory size of the initial memory area ZM to obtain for example a second memory size of 16 bits, greater than the first memory size (8 bits).

In step S10, the processor PROC implements the modified neural network by using the test input data set DT so as to formulate a quality factor for example the precision. A precision of 92% is for example obtained.

The processor PROC compares the quality factor formulated with another quality factor previously formulated during the implementation of the initial neural network RN for example 95%. There is therefore a difference of 3%.

If this difference is situated in the tolerance fixed by the user via the interface INT (for example +/−3%), the criterion is satisfied and the processor PROC replaces in step S12 the set of initial parameters by the new set of modified parameters.

Otherwise, the processor PROC retains the initial memory size of the initial memory areas ZM and replaces the initial weights PW by the new weights having the size reduced in step S11.

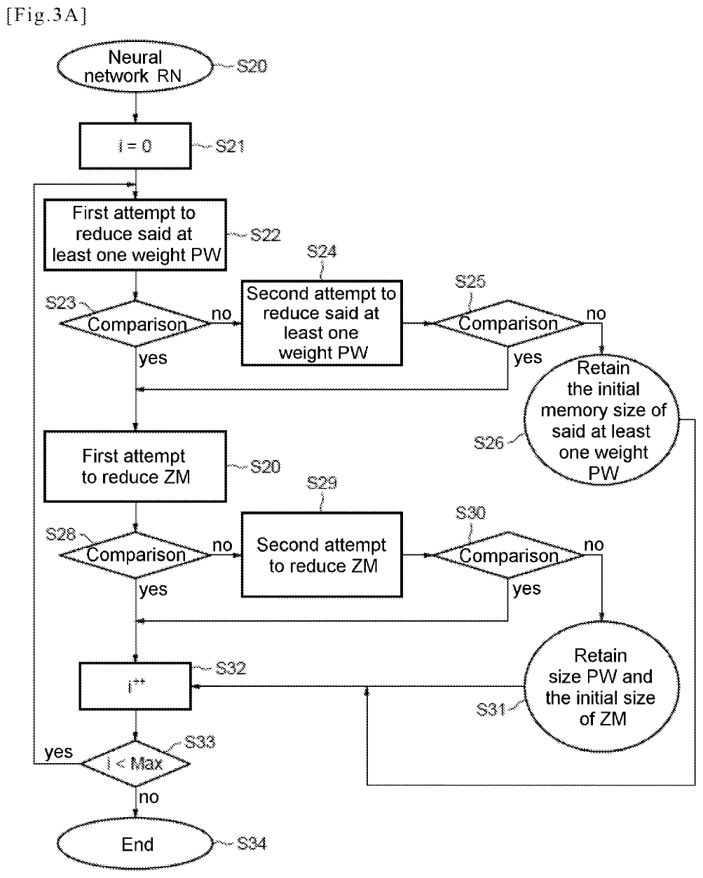

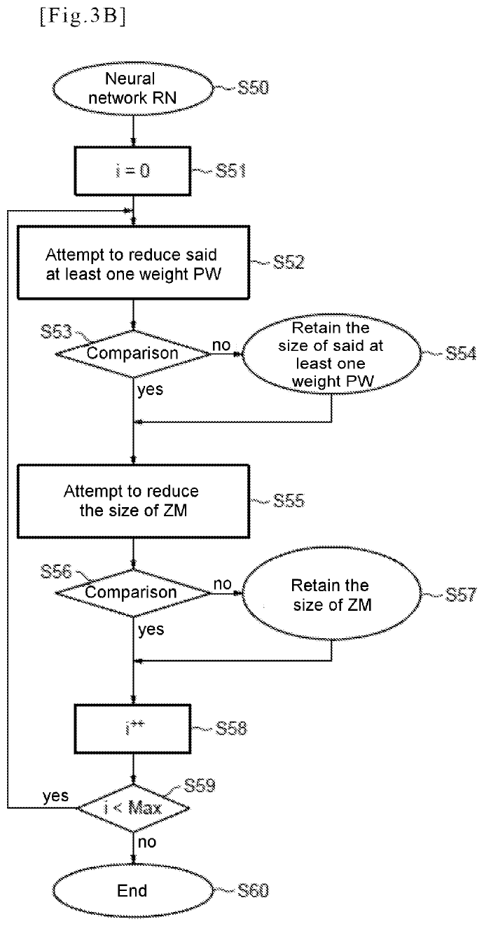

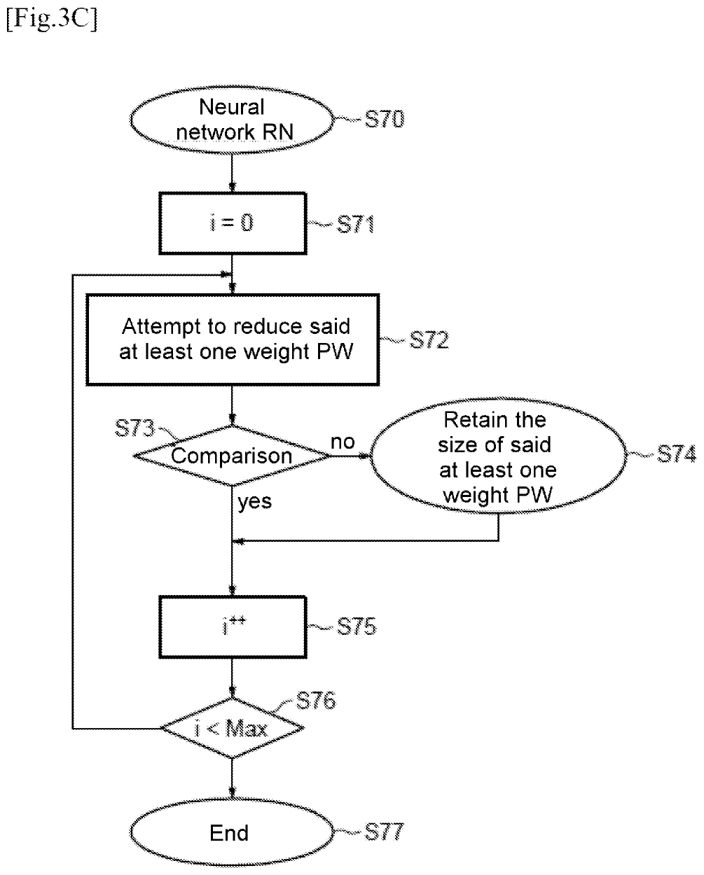

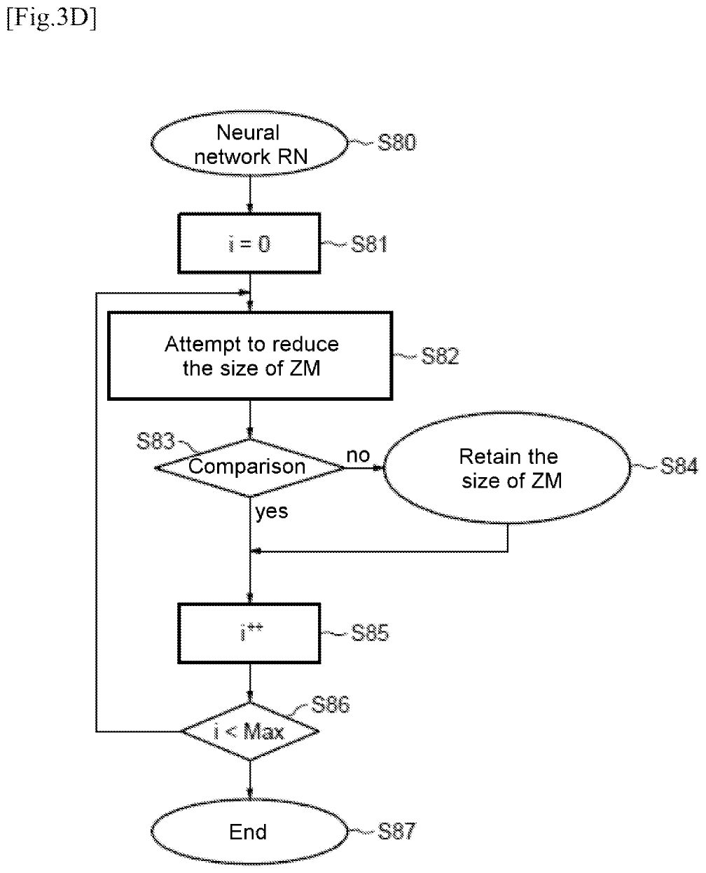

FIG. 3A represents an alternative to the algorithm for analyzing the set of initial parameters defining the neural network RN.

In step S20, the processor PROC extracts the layers of the initial neuron network RN.

The variable i that the processor PROC initializes to o in step S21 represents the layer number.

In step S22, the analysis unit MT performs a first reduction of the initial memory size of the weights PW of the first layer (i=o) of the initial neural network RN to obtain for example a first memory size of 8 bits.

The processor PROC implements the modified neural network RNM with the test input data set DT in step S23 and formulates a quality factor for example a precision of 80%.

It thereafter compares the quality factor with another quality factor previously formulated during the implementation of the initial neural network RN for example a precision of 95%. There is therefore a difference of 15%.

If this difference is situated in the tolerance fixed by the user via the interface INT (for example +/−15%), the criterion is satisfied and the processor PROC passes to step S20, otherwise to step S24.

In step S24, the analysis unit MT reduces the initial size of the weights of the layer i to obtain a second memory size, greater than the first memory size, for example 16 bits. The second memory size therefore represents here double the first memory size.

In step S25, the processor PROC implements the modified neural network RNM to formulate a quality factor for example a precision of 90%. There is therefore a difference of 5%.

If this difference is situated in the tolerance fixed by the user via the interface INT (for example +/−6%), the criterion is satisfied and the processor PROC passes to step S20, otherwise the analysis unit MT retains the initial memory size of the weights PW of the layer i and pass to the following layer by incrementing the value of i in step S32. If in step S33, the value of the variable i is greater than a variable Max representing the maximum number of layers, this means that the processor PROC has traversed all the layers (S34).

In step S20, the analysis unit MT reduces the size of the memory area ZM intended to store the output data of the layer i to a first size for example 8 bits.

In step S28, the processor PROC implements the modified neural network RNM to formulate a quality factor for example the precision and compare it with the quality factor previously formulated during the implementation of the initial neural network RN.

If the difference between the two quality factors is situated in the tolerance fixed by the user via the interface INT, the criterion is satisfied and the processor PROC passes to step S32, otherwise to step S29.

In step S29, the analysis unit MT reduces the initial memory size of the initial memory area ZM to obtain a second memory size for example of 16 bits. The second memory size represents double the first memory size.

In step S30, the processor PROC implements the modified neural network RNM to formulate a quality factor for example the precision.

If the difference between the two quality factors is situated in the tolerance margin fixed by the user via the interface, the criterion is satisfied and the processor PROC passes to step S32, otherwise the analysis unit MT retains in step S31 the initial memory size of the initial memory area ZM and the initial memory size of the weights PW and pass to the following layer by incrementing the value of i in step S32.

FIG. 3B represents an alternative to the algorithm for analyzing the set of initial parameters defining the neural network RN.

In step S50, the processor PROC extracts the layers of the initial neural network RN.

The variable i that the processor PROC initializes to o in step S51 represents the layer number.

Here, the initial memory size of the weights of the layer i and the initial memory size of the memory area of the layer i are equal, for example 16 bits.

In step S52, the analysis unit MT performs a reduction of the initial memory size of the weights PW of the first layer (i=o) of the initial neural network RN to obtain for example a memory size of 8 bits.

In step S53, the processor PROC implements the modified neural network RNM to formulate a quality factor for example the precision and compares it with the quality factor formulated previously by implementing the initial neural network RN.

If the difference between the two quality factors is situated in the tolerance fixed by the user via the interface INT, the criterion is satisfied and the processor PROC passes to step S55, otherwise the analysis unit MT retains in step S54 the initial memory size of the weights PW of the layer i and pass to step S55.

In step S55, the analysis unit MT performs a reduction of the initial memory size of the initial memory area ZM of the first layer i of the initial neural network RN to obtain for example a first memory size of 8 bits.

In step S56, the processor PROC implements the modified neural network RNM to formulate a quality factor for example the precision and compares it with the quality factor formulated previously by implementing the initial neural network RN.

If the difference between the two quality factors is situated in the tolerance margin fixed by the user via the interface INT, the criterion is satisfied and the processor PROC passes to step S58, otherwise the analysis unit MT retains in step S57 the initial memory size of the initial memory area ZM of the layer i and pass to step S58.

In step S58, the variable i is incremented by 1 so as to pass to the following layer and if in step S59 the value of i is greater than the value of the variable Max which represents the maximum number of layers, the processor PROC passes to step S60 which marks the end of the algorithm, otherwise to step S52.

FIG. 3C represents another alternative to the algorithm for analyzing the set of initial parameters defining the neural network RN.

In step S70, the processor PROC extracts the layers of the initial neuron network RN.

The variable i that the processor PROC initializes to o in step S71 represents the layer number.

Here, the initial memory size of the weights of the layer i is greater than the initial memory size of the memory area ZM of the same layer i.

In step S72, the analysis unit MT performs a reduction of the initial memory size of the weights PW of the first layer i of the initial neural network RN to obtain for example a memory size of 8 bits, equal to the initial memory size of the initial memory area ZM.

In step S73, the processor PROC implements the modified neural network RNM to formulate a quality factor for example the precision and compares it with the quality factor formulated previously by implementing the initial neural network RN.

If the difference between the two quality factors is situated in the tolerance fixed by the user via the interface, the criterion is satisfied and the processor PROC passes to step S75, otherwise the analysis unit MT retains in step S74 the initial memory size of the weights PW of the layer i and then pass to step S75.

In step S75, the processor PROC increments the value of i by 1 so as to pass to the following layer and if in step S76, the value of the variable i is greater than the value of the variable Max defined above, the processor PROC terminates the algorithm in step S77. Otherwise, the various steps of the algorithm are repeated from step S72 for the following layer.

FIG. 3D represents another alternative to the algorithm for analyzing the set of initial parameters defining the neural network RN.

In step S80, the processor PROC extracts the layers of the initial neuron network RN.

The variable i that the processor PROC initializes to o in step S81 represents the layer number.

Here, the initial memory size of the weights of the layer i is smaller than the initial memory size of the memory area ZM of the same layer i.

In step S82, the analysis unit MT performs a reduction of the initial memory size of the memory area ZM of the first layer i of the initial neural network RN to obtain for example a memory size of 8 bits, equal to the initial memory size of the weights PW of the layer i.

In step S83, the processor PROC implements the modified neural network RNM to formulate a quality factor for example the precision and compares it with the quality factor formulated previously by implementing the initial neural network RN.

If the difference between the two quality factors is situated in the tolerance fixed by the user via the interface INT, the criterion is satisfied and the processor PROC passes to step S85, otherwise the analysis unit MT retains in step S84 the initial memory size of the initial memory area ZM of the layer i and then pass to step S85.

In step S85, the processor PROC increments the value of i by 1 so as to pass to the following layer and if in step S86, the value of the variable i is greater than the value of the variable Max defined above, the processor PROC terminates the algorithm in step S87. Otherwise, the various steps of the algorithm are repeated from step S82 for the following layer.

It should be noted that the processor PROC can process the layers of the algorithms presented in FIGS. 3A to 3C from the first to the last layer and/or from the last to the first layer.

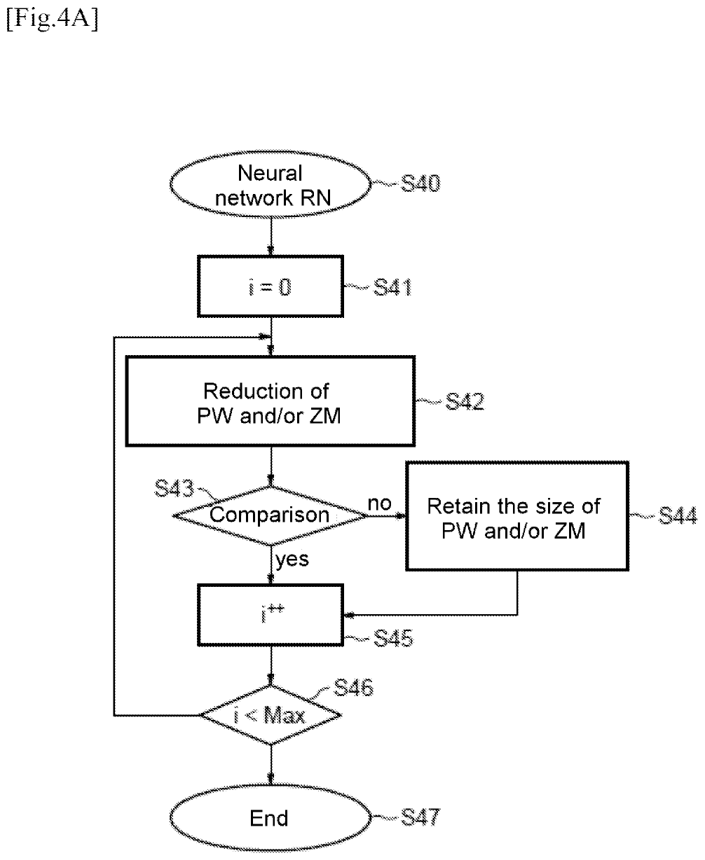

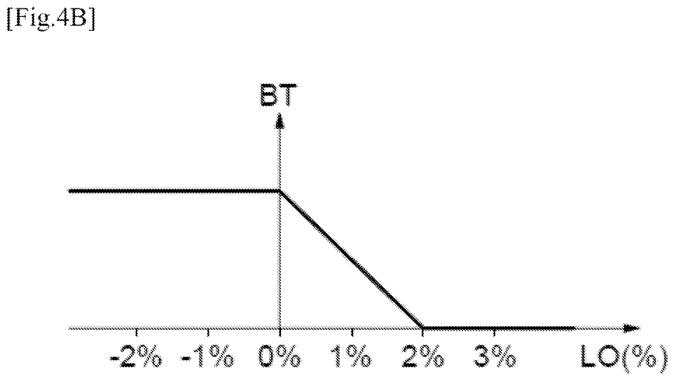

FIG. 4A represents another alternative to the algorithm for analyzing the set of initial parameters defining the neural network RN.

In step S40, the processor PROC extracts all the layers of the initial neuron network RN. The analysis unit MT performs classify the layers as a function of the criterion or criteria advised by the user in the user interface INT.

For example, if the user desires a gain in the volatile memory MV, it would be advantageous to reduce the initial memory size of the memory areas ZM of the potential layers.

If he desires a gain in the non-volatile memory MNV, it would be advantageous to reduce the initial memory size of the weights PW of the potential layers.

The user can also advise in the user interface INT a weighting factor for example 0.5 if the user confers the same importance on the gain in volatile memory and in non-volatile memory.

Hence, if the user chooses as sought-after technical improvement, a gain in processing time by the processor PROC, it is advantageous to reduce the initial memory size of the weights PW of each layer and/or the initial memory size of the memory areas ZM of each layer.

As a function of the type of technical improvement chosen, the analysis unit MT performs a ranking of the potential layers (candidates). An exemplary ranking is explained in FIG. 4B.

The variable i that the processor PROC initializes to o in step S41 represents the number of potential layers.

In step S42, as a function of the type or types of gain (types of technical improvement) chosen by the user, the analysis unit MT reduces the initial memory size of the weights PW of the potential layer and/or the initial memory size of the memory area ZM for example to 8 bits.

In step S43, the processor PROC implements the modified neural network RNM and formulates a quality factor for example the precision and compares it with the quality factor previously formulated during the implementation of the initial neural network RN.

If this difference is not situated in the tolerance fixed by the user via the interface INT, the criterion is not satisfied and the analysis unit MT retains in step S44, the initial memory size of the weights of the potential layer i and/or the initial memory size of the memory area ZM of the potential layer i. The processor PROC thereafter passes to step S45. If not, it passes directly to step S45 from step S43.

In step S46, the processor PROC increments the value of i by 1 so as to pass to the following potential layer.

If the value of the variable i is greater than the value of the variable Max in step S46, this means that the processor PROC has analysed and processed all the potential layers and therefore terminates the algorithm in step S47.

If not, the processor PROC passes to the analysis of the set of initial parameters of the following potential layer and repeats the steps of the algorithm from step S42.

FIG. 4B represents a graph describing the evolution of a variable BT as a function of another variable LO as a percentage.

The variable LO represents the percentage of loss of performance computed as a function of the type of the layer.

The percentage LO is determined by an attempted reduction of the initial memory size of the weights PW of the layer and/or the initial memory size of the memory area ZM and by the implementation of the modified neural network RNM with the set of test data.

The value of the variable BT contributes to the computation of a score associated with each layer. The score makes it possible to select the potential layers leading to a gain in memory or to a gain in processing time. The potential layers will be ranked according to the computed scores.

To compute the score for each layer in the case where the user chooses the gain in memory, it is possible to use the formula hereinbelow:

score=BT×(Alph×RAMG+(i-Alph)×ROMG)

The variable Alph corresponds to the weighting factor.

The variable RAMG corresponds to the gain in volatile memory expressed in bytes.

The variable ROMG corresponds to the gain in non-volatile memory expressed in bytes.

For each layer, if the computed percentage LO is smaller than o, this means that the reduction of the initial memory size of the memory area ZM and/or of the weights of the layer leads to a gain in memory and potentially to a gain in performance. In this case, the variable BT equals 1.

If the computed percentage LO is greater than 0, this is equivalent to a loss of performance. But if the percentage LO is also greater than the tolerance specified by the user (2% in this example), this means that the criterion is not satisfied. In this case, the variable BT equals o and consequently the score will be 0.

If the computed percentage LO is greater than o and smaller than the tolerance specified by the user, the variable BT decreases linearly as a function of the variable LO according to the formula hereinbelow:

BT=1−(LO/MG)

The scores are ranked in descending order and the layers having a score equal to 0 are not selected.

It is possible to use other mathematical formulae, known by the person skilled in the art, which make it possible to decrease the variable BT exponentially for example.

To compute the score for each layer in the case where the user chooses the processing time gain, it is possible to use the formula hereinbelow:

score=BT×CYG

The variable CYG corresponds to the gain in processing time.

For each layer, if the computed percentage LO is smaller than 0, this means that the reduction of the initial memory size of the memory area ZM and/or of the weights of the layer leads potentially to a gain in performance. In this case, the variable BT equals 1.

If the computed percentage LO is greater than 0, this is equivalent to a loss of performance. But if the percentage LO is also greater than the tolerance specified by the user, this means that the criterion is not satisfied. In this case, the variable BT equals 0 and consequently the score will be 0.

If the computed percentage LO is greater than 0 and smaller than the tolerance specified by the user, the variable BT decreases linearly as a function of the variable LO according to the formula hereinbelow:

### BT=1−(LO/MG)

The scores are ranked in descending order and the layers having a score equal to 0 are not selected.

Moreover, the invention is not limited to these embodiments and modes of implementation but embraces all variants thereof, for example the memory size of the memory area or the memory size of the weights can be reduced as many times as it is possible to do so as long as the criterion defined by the user is satisfied.

What is claimed is:

1. A method for use with a neural network being implemented by a system having a computation unit coupled to a collection of memories, the method comprising:
analyzing a set of initial parameters defining an initial multilayer neural network, the analyzing comprising attempting to reduce an initial memory size of an initial parameter so as to obtain a set of modified parameters defining a modified neural network with respect to the initial network.

2. The method according to claim 1, further comprising:
implementing, by the system, the initial neural network and the modified neural network by using a test input data set;
formulating a first quality factor for the initial neural network and a second quality factor for the modified neural network by using the test input data set;
comparing the first and second quality factors; and
accepting or refusing the reduction of the initial memory size of the parameter based on the comparison with regard to the satisfaction or non-satisfaction of a chosen criterion.

3. The method according to claim 2, wherein each layer of the initial neural network comprises an initial weight belonging to the set of initial parameters and having an initial memory size, the analyzing comprising:
first reducing the initial memory size of the initial weight to a first memory size for all the layers;
when refusing the reduction based on the comparison, performing a second reduction of the weight to a second memory size for all the layers, the second size being greater than the first size; and
when accepting the reduction based on the comparison, retaining (S6) the initial memory size of the initial weights of the initial neural network.

4. The method according to claim 3, wherein each layer of the initial neural network comprises an initial memory area intended to store output data, belonging to the set of initial parameters and having an initial memory size, the method comprising:
when accepting the reduction based on the comparison, reducing the initial memory size of all the initial memory areas to the first size; and
when refusing the reduction based on the comparison, performing the second reduction of the initial memory size of all the initial memory areas to the second size, repeating the formulating and comparing steps with the second size, if the second reduction is refused, retaining the initial memory size of the initial memory areas of the network.

5. The method according to claim 3, wherein the second size is double the first size.

6. The method according to claim 3, wherein on completion of the analyzing, the set of modified parameters of the modified neural network comprises the weight having a reduced memory size and all initial memory areas having a reduced memory size.

7. The method according to claim 3, wherein the modified set of parameters of the modified neural network comprises the weight having a reduced memory size and all initial memory areas having their initial memory size.

8. The method according to claim 2, wherein the quality factor comprises a precision factor.

9. The method according to claim 2, wherein the quality factor comprises a noise factor.

10. The method according to claim 2, wherein each layer of the initial neural network comprises an initial weight belonging to the set of initial parameters and having an initial memory size and each layer of the initial neural network comprises an initial memory area having an initial memory size intended to store output data belonging to the sets of initial parameters, the analyzing comprising:
performing a first reduction of the memory size of the weight of the layer to a first memory size;
when refusing the first reduction of the memory size of the weight based on a comparison, performing a second reduction of the initial memory size of the initial weight of the layer to a second memory size greater than the first memory size;
when refusing the second reduction of the initial memory size of the initial weight after a second comparison, retaining the initial memory size of the weight of the layer;
performing a first reduction of the initial memory size of the initial memory area of the layer to the first size;
when refusing the first reduction of the initial memory size of the initial memory area after a comparison, performing a second reduction of the initial memory size of the initial memory area of the layer to the second size;
when refusing the second reduction of the initial memory size of the initial memory area after a second comparison, retaining the initial memory size of the initial memory area and the initial memory size of the initial weight of the layer.

11. The method according to claim 2, wherein each layer of the initial neural network comprises an initial weight and an initial memory area intended to store output data belonging to the set of initial parameters, the initial weight having an initial memory size equal to the initial memory size of the initial memory area, the analyzing comprising:
reducing half the initial memory size of the initial weight of the layer;
when refusing the reduction after the comparison of the quality factors, retaining of the initial memory size of the initial weight and reducing by half the initial memory size of the initial memory area, and, upon refusing the reduction of memory size of the initial memory area after a comparison of quality factors, retaining the initial memory size of the initial memory area.

12. The method according to claim 2, wherein each layer of the initial neural network comprises an initial weight and an initial memory area intended to store output data belonging to the set of initial parameters, the initial weight having an initial memory size greater than the initial memory size of the initial memory area, the analyzing comprising reducing the initial memory size of the initial weight to the initial memory size of the initial memory area, and when refusing the reduction after the comparison of the quality factors, retaining the initial memory size of the initial weight.

13. The method according to claim 2, wherein each layer of the initial neural network comprises an initial weight and an initial memory area intended to store output data belonging to the set of initial parameters, the initial weight having an initial memory size smaller than the initial memory size of the initial memory area, the analyzing comprising reducing the initial memory size of the initial memory area to the initial memory size of the initial weight, and when refusing the reduction after the comparison of the quality factors, retaining of the initial memory size of the initial memory area.

14. The method according to claim 2, further comprising computing a score for each layer of the initial neural network as a function of a technical improvement sought and a selection of the layers having a score above a threshold.

15. The method according to claim 14, wherein the technical improvement sought is a gain in memory.

16. The method according to claim 15, wherein the collection of memories of the system comprises a volatile memory intended to be allocated to the initial memory area of the selected layer and a non-volatile memory intended to store the weight of the selected layer, and as a function of a weighting factor, the gain in memory comprises a gain in volatile memory or non-volatile memory or a gain in both memories, the gain in non-volatile memory corresponding to a reduction of the initial memory size of the weight of the selected layer, the gain in volatile memory corresponding to a reduction of the initial memory size of the initial memory area of the selected layer.

17. The method according to claim 14, wherein the technical improvement sought is a gain in processing duration.

18. A system, comprising:
a collection of memories;
a computation unit coupled to the memories, the computation unit comprising an analysis unit configured to perform an analysis of a set of initial parameters defining an initial multilayer neural network intended to be implemented by the system (SYS), the analysis unit being configured to attempt to reduce the initial memory size of an initial parameter so as to obtain a set of modified parameters defining a modified neural network with respect to the initial network, wherein the computation unit is further configured to:
implement the initial neural network and the modified neural network by using a test input data set;
formulate a quality factor for the initial neural network and a quality factor for the modified neural network by using the set of test inputs;
perform a comparison between the quality factor for the initial neural network and the quality factor for the modified neural network; and
deliver an acceptance or refusal decision with respect of the reduction of the initial memory size of the parameter as a function of a result of the comparison with regard to the satisfaction or non-satisfaction of a chosen criterion.

19. The system according to claim 18, wherein each layer of the initial neural network comprises an initial weight belonging to the set of initial parameters and having an initial memory size, the analysis unit being configured to perform a first reduction of the initial memory size of the initial weight to a first memory size for all the layers, and in case of refusal of the first reduction after the comparison, the analysis unit is configured to perform a second reduction of the initial weight to a second memory size for all the layers, the second memory size being greater than the first memory size, and in case of refusal of the second reduction, the analysis unit is configured to retain the initial memory size of the initial weights of the initial neural network.

20. The system according to claim 18, wherein each layer of the initial neural network comprises an initial memory area intended to store output data belonging to the set of initial parameters and having an initial memory size, the analysis unit being configured to, if the initial memory size of the initial weight has been reduced, perform a first reduction of the initial memory size of all the initial memory areas to the first size, and in case of refusal of the first reduction after a comparison by the computation unit, the analysis unit is configured to perform a second reduction of the initial memory size of all the initial memory areas to the second size, and in case of refusal of the second reduction after a second comparison by the computation unit, the analysis unit is configured to retain the initial memory size of the initial memory areas.

21. The system according to claim 19, wherein the second size is double the first size.

22. The system according to claim 19, wherein the set of modified parameters of the modified neural network comprises the weight having a reduced memory size and all the initial memory areas having a reduced memory size.

23. The system according to claim 19, wherein the modified set of parameters of the modified neural network comprises the weight having a reduced memory size and all the initial memory areas having their initial memory size.

24. The system according to claim 18, wherein each layer of the initial neural network comprises an initial weight and an initial memory area intended to store output data belonging to the set of initial parameters, the initial weight having an initial memory size equal to the initial memory size of the initial memory area, the analysis unit being configured to perform a reduction by half of the initial memory size of the initial weight of the layer, and in case of refusal of the reduction after the comparison by the computation unit, the analysis unit is configured to retain the initial memory size of the initial weight and to perform a reduction by half of the initial memory size of the initial memory area, and in case of refusal of the reduction of the initial memory size of the initial memory area after the comparison, the analysis unit is configured to retain the initial memory size of the initial memory area.

25. The system according to claim 18, wherein each layer of the initial neural network comprises an initial weight and an initial memory area intended to store output data belonging to the set of initial parameters, the initial weight having an initial memory size greater than the initial memory size of the initial memory area, the analysis unit being configured to perform a reduction of the initial memory size of the initial weight to the initial memory size of the initial memory area, and in case of refusal after a comparison by the computation unit, the analysis unit is configured to retain the initial memory size of the at least one weight.

26. The system according to claim 18, wherein each layer of the initial neural network comprises an initial weight and an initial memory area intended to store output data belonging to the set of initial parameters, the initial weight having an initial memory size smaller than the initial memory size of the initial memory area, the analysis unit being configured to reduce the initial memory size of the initial memory area to the initial memory size of the at least one initial weight, and in case of refusal of the reduction after a comparison by the computation unit, the analysis unit is configured to retain the initial memory size of the initial memory area.

27. The system according to claim 18, wherein the analysis unit is configured to process the layers of the initial neural network from the first to the last layer or from the last to the first layer.

28. The system according to claim 18, wherein the quality factor comprises a precision factor.

29. The system according to claim 18, wherein the quality factor comprises a noise factor.

30. The system according to claim 18, wherein the computation unit is configured to compute a score for each layer of the initial neural network as a function of the criterion and to select the layers having a score above a threshold.

31. The system according to claim 3o, wherein each layer selected by the analysis unit comprises a weight having an initial memory size and an initial memory area intended to store output data and having an initial memory size, the analysis unit being configured to perform the reduction of the initial memory size of the initial memory area and/or of the weight of the selected layer to a chosen size, and in case of refusal of the reduction after the comparison by the computation unit, the analysis unit is configured to retain the initial memory size of the initial weight and/or of the initial memory area, and to pass to the following selected layer.

32. The system according to claim 18, wherein the collection of memories of the system comprises a volatile memory intended to be allocated to the initial memory area of the selected layer and a non-volatile memory intended to store a weight of the selected layer, and as a function of a weighting factor, the gain in memory comprises a gain in volatile memory or non-volatile memory or a gain in both memories, the gain in non-volatile memory corresponding to a reduction of the initial memory size of the at least one weight of the layer selected by the analysis unit, the gain in volatile memory corresponding to a reduction of the initial memory size of the initial memory area of the layer selected by the analysis unit.
